(19) United States
(12) Patent Application Publication
(10) Pub. No.: US 2015/0141568 A1
(43) Pub. Date: May 21, 2015

(54) MATTE CLEAR COATING COMPOSITION

(71) Applicant: Hyundai Motor Company, Seoul (KR)

(72) Inventor: Seung Yul Yoon, Seoul (KR)

(21) Appl. No.: 14/316,132

(22) Filed: Jun. 26, 2014

(30) Foreign Application Priority Data
Nov. 18, 2013 (KR) 10-2013-0139965

(51) Int. Cl. C09D 133/12

(52) U.S. Cl. CPC C09D 133/12
USPC 524/523

(57) ABSTRACT

The present invention provides a matte clear coating composition comprising: a paint resin having a refractive index of about 1.48-1.50 and a specific gravity of about 1.1-1.2; and an organic resin having a refractive index that differs from the paint resin's refractive index by about 0-0.02 and from the specific gravity by about 0-0.2. The matte clear coating composition has good storage stability, minimized hiding of the base color by the matting agent, and improved physical properties, including adhesion and water resistance properties.

### CROSS-REFERENCE TO RELATED APPLICATION

This application claims under 35 U.S.C. §119(a) the benefit of Korean Patent Application No. 10-2013-0139965 filed on Nov. 18, 2013, the entire contents of which are incorporated herein by reference.

### BACKGROUND

(a) Technical Field

The present invention relates to a matte clear coating composition, and more particularly to a matte clear coating composition, which comprises a paint resin having a refractive index of about 1.48-1.50 and a specific gravity of about 1.1-1.2, and polymer beads having a refractive index and specific gravity equal or similar to those of the paint resin. The composition may further contain suitable amounts of one or more of an acrylic resin, a polyester resin, a curing agent, an additive, and a solvent. The coating composition according to the present invention provides reduced gloss even when being wiped compared to conventional inorganic clear coatings, thus maintaining a matt state, and exhibits a new texture to satisfy the consumer's demand for a matt material.

(b) Background Art

Recently, there has been an increase in consumer demand for matt materials in various kinds of products, including cars, electronic products, and plastic products.

In particular, coatings for cars were originally black in color, but recently, coatings having various colors have been developed to satisfy consumer demand. In addition, with the recent appearance of sports cars and luxury cars adopting matte clear coatings, consumer demand for matt cars is on the rise.

In conventional matte clear coatings, an inorganic matting agent, such as silicate, is used to reduce gloss. In recent years, a hybrid matting agent comprising a mixture of silicate and talc has been used in matte clear coatings for cars to reduce gloss and exhibit new textures.

However, matte clear coatings containing the inorganic matting agent relatively easily become glossy when wiped, and the inorganic matting agent has the effect of hiding the color of the base coating. Thus, such coatings are limited in their application to only dark colors. In addition, the matte clear coatings are problematic in that the specific gravity of the inorganic matting agent (about 2-2.2) is higher than that of the clear paint resin (about 1.1-1.2). Thus, precipitation of the matting agent occurs during storage of the clear coatings.

Korean Patent Laid-Open Publication No. 2010-121131 describes a thermoplastic polyester resin composition having reduced gloss and improved heat resistance, which comprises a thermoplastic polyester resin, an aromatic polycarbonate resin, an impact modifier, a matting agent and a weather stabilizer. According to the disclosure of the patent publication, when the composition containing the matting agent is injection-molded, fine irregularities are formed on the surface of the molded product to induce the scattering of light to thereby suppress the gloss of the surface. However, the composition has shortcomings in that because the specific gravity of the matting agent is higher than that of the clear paint resin, the matting agent precipitates when the clear coating composition is stored for a long period of time. Further, the composition becomes glossy when it is frequently wiped.

Therefore, there is an urgent need for a composition that is more suitable for use as a matte clear coating composition.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention solves the above-described problems associated with the prior art, and provides an improved coating composition. In particular, the coating composition comprises a paint resin and a matting agent consisting of polymer beads having a refractive index and specific gravity equal or similar to those of the paint resin. The composition can further comprise suitable amounts of one or more of an acrylic resin, a polyester resin, a curing agent, an additive, and a solvent. The composition of the present invention shows reduced gloss even when being wiped, so as to be maintained in a matt state, and further has improved storage stability.

According to embodiments of the present invention, a matte clear coating composition is provided which has good storage stability because it contains a matting agent that does not precipitate even when the composition is stored for a long period of time. Further, the hiding of the base color by the matting agent is minimized, and desirable physical properties are provided, including adhesion and water resistance properties.

To achieve the above properties, in one aspect, the present invention provides a matte clear coating composition comprising a clear paint resin and polymer beads, wherein the polymer beads have a refractive index and specific gravity equal or similar to those of the clear paint resin.

In an exemplary embodiment, the polymers are contained in an amount of about 15-40 parts by weight based on 100 parts by weight of the paint resin.

According to various embodiments, the paint resin may be any conventional paint resin, and in an exemplary embodiment, is one or more selected from the group consisting of acrylic resin, polyester resin, and a mixture thereof.

According to various embodiments, the matte clear coating composition further comprises one or more of a surface modifier, a curing agent, and an additive.

According to various embodiments, the polymer beads may be any conventional polymer beads, and according to an exemplary embodiment, the polymer beads are acrylic resins.

In still yet another exemplary embodiment, the acrylic resin is either polymethylmethacrylate (PMMA) or polybutylmethacrylate (PBMA).

The polymer beads are provided with a suitable particle size, and in exemplary embodiments, the polymer beads have a particle size of about 10-20 μm.

According to various embodiments, the surface modifier may be any conventional surface modifier, and according to an exemplary embodiment, the surface modifier is based on silicon or polyethylene.

According to various embodiments, the curing agent may be any conventional curing agent, and according to an exemplary embodiment, the curing agent is melamine formaldehyde.

In various embodiments, the matte clear coating composition further comprises about 1.0-2.0 wt % of one or more additives selected from the group consisting of an optical stabilizer, a pinhole preventing agent, and an anti-sagging agent.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a micrograph of polymer beads according to an embodiment of the present invention;

FIG. 2 shows the diffused reflection of light on the surface of a coating layer formed by applying a matte clear coating composition containing a conventional inorganic matting agent; and

FIG. 3 shows the diffused reflection of light on the surface of a coating layer formed by applying a matte clear coating composition containing polymer beads according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, the present invention will be explained in detail with reference to Tables and the accompanying drawings.

The present invention provides a matte clear coating composition comprising: a paint resin having a refractive index of about 1.48-1.50 and a specific gravity of about 1.1-1.2; and polymer beads having a refractive index and specific gravity similar to or equal to those of the paint resin. Preferably, the polymer beads have a refractive index that differs from the refractive index of the paint resin by about 0-0.02 and further have specific gravity that differs from the specific gravity of the paint resin by about 0-0.2.

In particular, the matte clear coating composition contains polymer beads as a matting agent, in which the polymer beads are preferably acrylic resins. More preferably, the acrylic resin that is used in the present invention is either polymethylmethacrylate (PMMA), polybutylmethacrylate (PBMA), or combinations thereof. The use of this acrylic resin can be advantageous for minimizing the differences in refractive index and specific gravity from those of the paint resin.

The polymer beads that are used in the present invention preferably have a particle size of about 10-20 μm. If the particle size of the polymer beads is smaller than 10 μm, the matting effect will be insufficient, and for this reason, the resin beads would then need to be added in an excessive amount of 35 wt % or more in order to exhibit low gloss. However, this results in deterioration in the physical properties (e.g., adhesion) of a coating layer formed of the composition. If the particle size is larger than 20 μm, the matting effect will be good, but these large particles look like foreign matter on the surface of the clear coat surface, thus reducing appearance and merchantability. For this reason, polymer beads having a particle size in the above range are preferably used.

In addition, the polymer beads that are used in the present invention preferably have a refractive index and specific gravity equal or similar to those of the paint resin. When the polymer beads that are used as the matting agent have a refractive index equal or similar to that of the paint resin, the hiding of the base color by the matting agent can be minimized. In addition, when the polymer beads have a specific gravity equal or similar to that of the paint resin, the matting agent will not precipitate even when the composition is stored for a long period of time.

Accordingly, it is preferable to use polymer beads having a refractive index equal or similar to the refractive index of a clear paint resin (about 1.48-1.50). More preferably, the difference in refractive index of the polymer beads from the refractive index of the clear paint resin is in the range from about 0 to 0.02.

In addition, it is preferable to use polymer beads having a specific gravity equal or similar to the specific gravity of a clear paint resin (about 1.1-1.2). More specifically, the difference in specific gravity of the polymer beads from the specific gravity of the clear paint resin is in the range from about 0 to 0.2.

When a conventional organic matting agent such as silicate or talc is used to reduce gloss, the composition easily becomes glossy when being wiped, and the inorganic matting agent has the effect of hiding the base color, and thus can be applied only to dark colors. According to the present invention, the shortcomings of the inorganic matting agent are overcome by using polymer beads having a refractive index and specific gravity equal or similar to those of the clear paint resin.

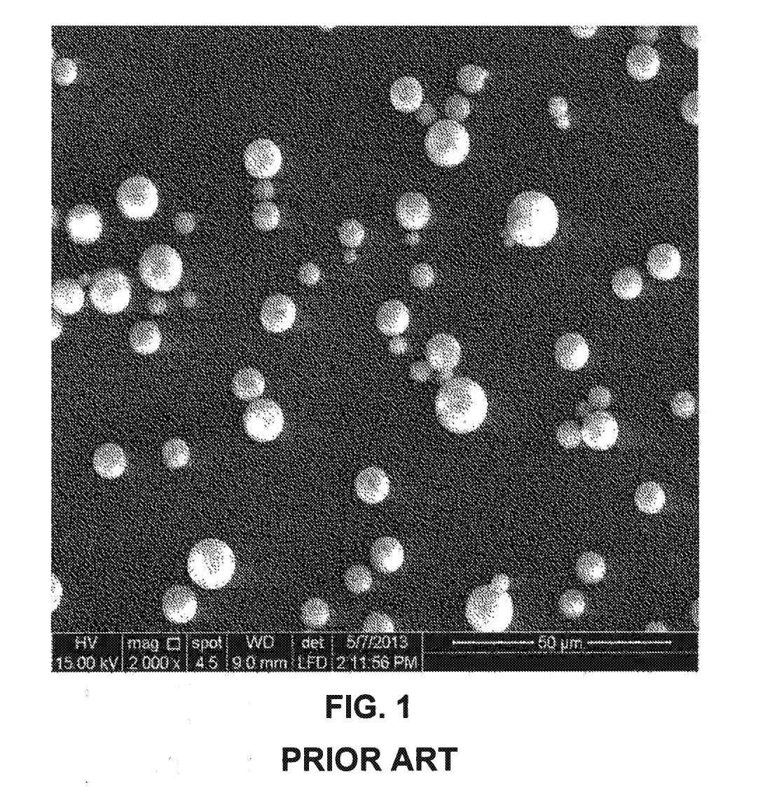

Moreover, because the specific gravity of the polymer beads (about 1.1-1.2) is lower than that of the inorganic matting agent (about 2-2.2), it cannot precipitate during storage of the clear coating composition. Thus, the matte clear coating composition according to the present invention has a high storage stability. FIG. 1 shows a micrograph of polymer beads according to the present invention. Specifically, FIG. 1 shows the appearance of spherical clear PMMA resin beads having a particle size of 15 μm and a refractive index of 1.49.

In addition, the polymer beads are preferably contained in an amount of about 15-40 parts by weight based on 100 parts by weight of the paint resin. If the content of the beads is less than 15 parts by weight, the 60° gloss of the composition will be more than 20±3, and if the content of the beads is more than 40 parts by weight, the 60° gloss of the composition will be less than 20±3. For this reason, the beads are preferably used in an amount within the above range.

According to embodiments of the present invention, the paint resin may be any conventional paint resin, and according to preferred embodiments, is one or more selected from among acrylic resin, polyester resin, and a mixture thereof. In addition, the coating composition may further comprise one or more of a surface modifier, a curing agent, and an additive.

In an exemplary embodiment, the matte clear coating composition comprises about 25-40 wt % of a paint resin comprising one or more materials selected from the group consisting of acrylic resin, polyester resin, and a mixture thereof, about 10-25 wt % of polymer beads, about 0.5-2.0 wt % of a surface modifier, about 10-20 wt % of a curing agent, about 1.0-2.0 wt % of an additive, and about 24-50 wt % of a solvent.

The polymer beads according to the present invention are preferably contained in an amount of about 10-25 wt % based on the total weight of the matte clear coating composition. If the content of the beads is less than 10 wt %, the 60° gloss of the composition will be more than 20±3, and if the content of the beads is more than 25 wt %, the 60° gloss of the composition will be less than 20±3. For this reason, the beads are preferably used in an amount within the above range.

In addition, the matte clear coating composition comprising the polymer beads according to the present invention preferably comprises a surface modifier. The surface modifier allows the resin beads to float to the surface of the coating layer after matte clear coating in a wet state to thereby maximize the matting effect of the resin beads. As the resin beads float to the surface of the coating layer, they form irregularities on the surface of the coating layer to reduce the friction of the surface. Thus, the loss of the polymer beads is reduced compared to that of conventional inorganic matting agents so that the occurrence of gloss upon wiping is reduced. According to the present invention, the surface modifier is preferably based on silicon or polyethylene.

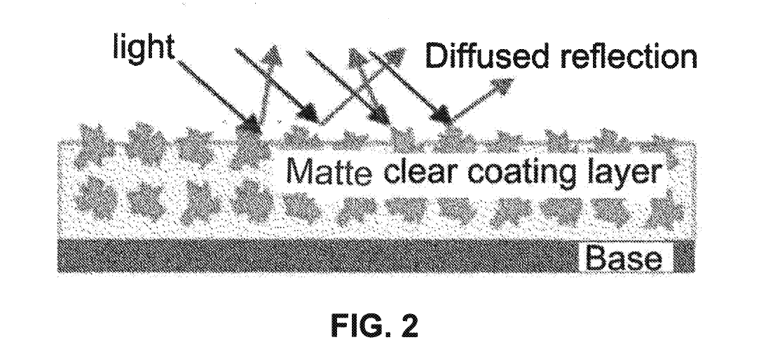

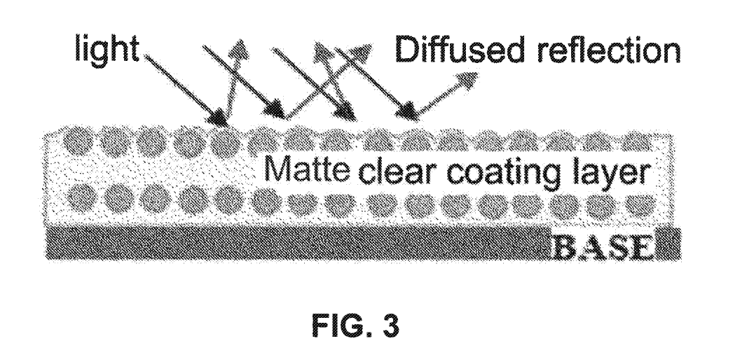

FIG. 2 shows the diffused reflection of light on the surface of a coating layer formed by applying a matte clear coating composition containing a conventional inorganic matting agent, and FIG. 3 shows the diffused reflection of light on the surface of a coating layer formed by applying a matte clear coating composition containing an organic matting agent according to an embodiment of the present invention.

As shown in FIGS. 2 and 3, in the case of a matte clear coating composition containing a conventional inorganic matting agent, the color can look turbid due to the difference in refractive index between the inorganic matting agent and the clear paint resin. On the other hand, in the case of the matte clear coating composition containing the organic matting agent according to the present invention, the base color is clear because the difference in refractive index between the organic matting agent and the clear resin is insignificant.

In addition, the surface modifier is preferably contained in an amount of about 0.5-2.0 wt % based on the total weight of the matte clear coating composition. If the content of the surface modifier is less than 0.5 wt %, the smoothness of a layer formed of the coating composition will be reduced, and if the content of the surface modifier is more than 2.0 wt %, the adhesion of the coating composition will be reduced. For this reason, the content of the surface modifier is preferably within the above range.

Preferably, the paint resin may be one or more selected from the group consisting of acrylic resin, polyester resin and a mixture thereof, and the content thereof in the composition is preferably about 25-40 wt % based on the total weight of the matte clear coating composition. According to an exemplary embodiment, the paint resin comprises acrylic resin as a main resin and polyester resin as a minor resin and may further comprise a curing agent if desired.

The content of acrylic resin in the coating composition is preferably about 22-30 wt % based on the total weight of the matte clear coating composition. If the content of acrylic resin is less than 22 wt %, the physical properties of the coating composition will be deteriorated, and if the content of acrylic resin is more than 30 wt %, the workability of the coating composition will be reduced. In addition, the content of polyester resin in the coating composition is preferably about 5-10 wt % based on the total weight of the matte clear coating composition. If the content of polyester resin in the coating composition is less than 5 wt %, the adhesion of the coating composition to the underlying coating layer will be reduced, and if the content of the polyester resin is more than 10 wt %, the physical properties of the composition will be reduced.

The curing agent may be any conventional curing agent, and preferably is melamine formaldehyde, and the content thereof in the coating composition is preferably about 10-20 wt % based on the total weight of the matte clear coating composition. If the content of the curing agent in the composition is less than 10 wt %, the major physical properties of the composition will be deteriorated due to insufficient curing, and if the content of the curing agent is more than 20 wt %, the impact resistance of the composition will be reduced.

In addition, the coating composition may further comprise about 1.0-2.0 wt % based on the total weight of the matte clear coating composition of one or more additives selected from the group consisting of an optical stabilizer, a pinhole preventing agent, and an anti-sagging agent.

The optical stabilizer serves to prevent the composition from being aged by UV light and may be selected from any conventional optical stabilizers, such as Tinuvin 1130 (UVA), Tinuvin 292 (HALS) or a mixture thereof. The content of the optical stabilizer in the composition is preferably about 1.0-2.0 wt % based on the total weight of the matte clear coating composition. If the content of the optical stabilizer in the composition is less than 1.0 wt %, the weather resistance of the composition will be reduced, and if the content of the optical stabilizer is more than 2.0 wt %, the appearance quality of a coating layer formed of the composition can be reduced.

The pinhole preventing agent serves to prevent pinholes from being formed and may be any conventional pinhole preventing agent, and is preferably an acrylic copolymer. The content of the pinhole preventing agent in the composition is preferably about 1.0-2.0 wt % based on the total weight of the matte clear coating composition. If the content of the pinhole preventing agent is less than 1.0 wt %, the effect of preventing pinholes from being formed in the coating will be reduced, and if the content of the pinhole preventing agent is more than 2.0 wt %, the appearance quality of a coating layer formed of the composition can be reduced.

The anti-sagging agent serves to prevent sagging of the coating composition and may be any conventional anti-sagging agent, and preferably is an acrylic derivative. The content of the anti-sagging agent in the composition is preferably about 0.1-2.0 wt %, and more preferably about 0.1-1.0 wt % based on the total weight of the matte clear coating composition. If the content of the anti-sagging agent is less than 0.1 wt %, the effect of preventing sagging of the coating composition will be reduced, and if the content of the anti-sagging agent is more than 2.0 wt %, the smoothness of the coating layer will be reduced.

In addition, the solvent that is used in the matte clear coating composition of the present invention serves to impart coating workability and may be any conventional solvent, and preferably is selected from a hydrocarbon-based solvent, an alcohol-based solvent, a glycol-based solvent, or a mixture thereof. The content of the solvent in the composition is preferably about 24-50 wt % based on the total weight of the matte clear coating composition. If the content of the solvent in the composition is less than 24 wt %, the viscosity of the composition will be reduced, resulting in a decrease in the spray coating workability of the composition, and if the content of the solvent in the composition is more than 50 wt %, the viscosity of the composition will be reduced, and thus the flowability of the coating composition will be reduced.

As described above, the matte clear coating composition according to the present invention comprises polymer beads having a refractive index and specific gravity equal or similar to the clear paint resin. Thus, the composition has good storage stability because the matting agent does not precipitate even when the composition is stored for a long period of time, the hiding of the base color by the matting agent is minimized, and the composition has desired physical properties, including adhesion and water resistance properties. Accordingly, the composition of the present invention can be used in a wide range of applications requiring a matt appearance, including plastic components, electronic products, and car exterior materials.

Hereinafter, the present invention will be described in further detail with reference to examples. It is to be understood, however, that these examples are for illustrative purposes and are not intended to limit the scope of the present invention.

### Examples

The following examples illustrate the invention and are not intended to limit the same.

### Examples 1 and 2

According to the components and contents shown in Table 1 below, a matte clear coating compositions were prepared. Then, a blue aqueous base coating was applied to a specimen to a thickness of 13-15 μm and dried at 80° C. for 2 minutes and 30 seconds. Then, the prepared matte clear coating compositions were applied to the base coating layer to a thickness of 40 μm and cured at 150° C. for 20 minutes, thereby preparing test specimens having a clear coating layer formed thereon. The formed clear coating layer as would be formed in accordance with Examples 1 and 2 is depicted in FIG. 3.

### Comparative Example

In the same manner as described in Examples 1 and 2, a matte clear coating composition and a test specimen were prepared using the components shown in Table 1 below. The formed clear coating layer is shown in FIG. 2.

TABLE 1
Matte clear coating compositions (unit: wt %)

| | | Content of matte clear | | |
|---|---|---|---|---|
| | | coating compositions | | |
| | | Comparative | | |
| Components | | Example | Example 1 | Example 2 |
| Matting | Silicate | 3.6 | — | — |
| agent | Talc | 2.4 | — | — |
| | PMMA resin beads | — | 21.2 | 14.3 |
| | (particle size: 15 μM, | | | |
| | refractive index: 1.49, | | | |
| | specific gravity: 1.1) | | | |
| Resin | Acrylic resin | 31.5 | 26.1 | 27.4 |
| | Polyester resin | 8.5 | 7.6 | 8.2 |
| Curing | Melamine | 14.8 | 12.4 | 14.2 |
| agent | formaldehyde | | | |
| Additive | optical stabilizer | 1.6 | 1.7 | 1.6 |
| | pinhole preventing | 1.8 | 1.6 | 1.5 |
| | agent: acrylic | | | |
| | copolymer | | | |
| | surface modifier: | 1.7 | 1.8 | 0.9 |
| | silicone modified | | | |
| | acryl | | | |
| | anti-sagging agent: | 0.2 | 0.2 | 0.2 |
| | acrylic derivative | | | |
| Solvent | hydrocarbon-based | 13.7 | 11.5 | 14.7 |
| | alcohol-based | 11.1 | 8.5 | 9.4 |
| | glycol-based | 9.1 | 7.4 | 7.6 |

| | | | |
|---|---|---|---|
| Total | 100 | 100 | 100 |

The physical properties of the matte clear coating layers formed on the specimens in Examples 1 and 2 and the Comparative Example, and the results of the measurement are shown in Table 2 below.

TABLE 2
Physical properties of matte clear coating layer formed on specimen

| | | | Evaluation results | | |
|---|---|---|---|---|---|
| | | | Comparative | Example | Example |
| Evaluation items | | Evaluation criteria | Example | 1 | 2 |
| Matte | state in | No foreign substances and | good | Good | good |
| clear | container | uniform dispersion during stirring | | | |
| paint | viscosity | Conformity to agreement with | 32 sec | 31 sec | 34 sec |
| | | manufactuter (FORD CUP #4) | | | |
| | dilution | No remarkable precipation and | good | Good | good |
| | stability | uniform dispersion during stirring | | | |
| | storage | No remarkable difference | 2 | 3 | 4 |
| | stability | compared to before storage | months | months | months |
| | Specific | 0.9-1.2 | 0.998 | 0.987 | 0.987 |
| | gravity | | | | |
| | non- | More than 50% | 51.4% | 50.9% | 50.1% |
| | volatile | | | | |
| | content | | | | |
| Test | Gloss | Low gloss (60° gloss meter): | 21 | 22.4 | 20.1 |
| specimens | | 20 ± 3 | | | |
| formed | Gloss | Gloss increase ration (%) | 87% | 48% | 32% |
| with clear | after wiping | after wiping | | | |
| coating | hardness | More than B | HB | HB | HB |
| layer | Impact | DuPONT type impact tester/more | 50 cm | 50 cm | 50 cm |
| | resistance | than 20 cm | | | |
| | Adhesion to | More than M-2.5 | M-1.0 | M-1.0 | M-1.0 |
| | material | | | | |
| | recoatability | 1. recoated portion MARK and no | good, | good, | good, |
| | | dichroic phenomenon | M-1 | M-1 | M-1 |
| | | 2. NO SANDING portion's | | | |
| | | adhesion/more than M-2.5 | | | |
| | chromomacity | Chroma difference(ΔC) | reference | ΔC = +2.1 | ΔC = +2.3 |
| | water | More than M-2.5 grade, no | M-1 | M-1 | M-1 |
| | resistance | change in appearance | | | |
| | moisture | More than M-2.5 grade, no | M-1 | M-1 | M-1 |
| | resistance | change in appearance | | | |
| | weather | gloss retention: 90%↑, adhesion: | 98.7%/ | 98.5%/ | 99.2%/ |
| | resistance | M-2.5↑ | M-1 | M-1 | M-1 |
| | | discoloration (ΔE) = 1.0↓ (white- | ΔE = | ΔE = | ΔE = |
| | | based), 3.0↓ (other colors) | 0.64 | 0.75 | 0.63 |

### Test Examples: Measurement of Physical Properties

### Test Example 1

### Measurement of Physical Properties of Matte Clear Paint

The physical properties of the matte clear coating compositions shown in Table 2 above were evaluated in the following manner.

(1) Evaluation of state of composition in container: A container containing each composition was opened, and the composition in the container was stirred with a spatula. The presence or absence of hard masses in the composition and whether a precipitate in the composition was easily dispersed were visually observed.

(2) Evaluation of viscosity: The viscosity of the composition was measured with FORD CUP #4.

(3) Evaluation of dilution stability: The coating composition was diluted with a thinner, and the dilution was stirred with a spatula and allowed to stand. Then, the degree of precipitation and dispersion in the dilution was observed.

(4) Evaluation of storage stability: The coating composition was placed and sealed in a 1-liter can and stored at a temperature of 35° C. Then, the change in the viscosity of the composition was measured at 1-month intervals, and the time point at which the viscosity reached less than 90% of the original viscosity was recorded.

(5) Measurement of specific gravity: The specific gravity of the composition was measured using a specific gravity cup (BYK Gardner).

(6) Evaluation of non-volatile content: The non-volatile content of the coating composition was measured by drying 3 of the coating composition at 105° C. for 3 hours and then calculating the change in the weight of the composition.

### Test Example 2

### Measurement of Physical Properties of Test Specimens

The physical properties of seven test specimens having the clear coating layer formed in each of the Examples and the Comparative Examples were measured in the following manner, and five measurements, excluding the highest value and the lowest value, were averaged.

(1) Measurement of gloss: The gloss of the specimen was measured using a 60° gloss meter (BYK-Gardner).

(2) Gloss after wiping: A friction element covered with cotton cloth was reciprocated 500 times on the specimen under a load of 2 kg, and then the gloss of the specimen was measured using a 60° gloss meter (BYK-Gardner).

(3) Measurement of pencil hardness: The pencil hardness of the coating layer was evaluated according to ISO 15184 and JIS K 5600-5-4.

(4) Measurement of impact resistance: According to ISO 6272, a weight of 500 g was dropped on the coating layer, and then the state of the coating layer was observed.

(5) Measurement of adhesion to material: The adhesion of the coating layer to the specimen was measured at 2-mm intervals.

(6) Measurement of recoatability: The surface of the clear coating layer was polished with hand, and then a base/clear coating was applied to the surface and dried, and the adhesion of the applied base/clear coating was evaluated.

(7) Measurement of chromaticity: The chromaticity of the clear coating layer was measured using a colorimeter (BYK-Gardner). Herein, the base color was blue.

(8) Measurement of water resistance: The specimen was allowed to stand in a water-filled chamber at 40° C. for 240 hours, and then the changes in appearance (discoloration, cracking, swelling and the like) and the adhesion of the coating layer were observed.

(9) Measurement of moisture resistance: The specimen was left to stand in a water-filled chamber at 50° C. for 96 hours, and then the changes in appearance (discoloration, cracking, swelling and the like) and the adhesion of the coating layer were observed.

(10) Measurement of weather resistance: The spacemen was subjected to an exposure test using a weathering system (Atlas) for 1000 hours, and then the gloss retention, discoloration, and adhesion of the specimen were evaluated.

As can be seen in Table 2 above, the compositions of Examples 1 and 2 showed a storage stability of 3 months, which was one-month longer than that of the composition of Comparative Example 1.

In addition, the degree of gloss before wiping was similar between the compositions of the Examples and the Comparative Example, but after the friction element covered with cotton cloth was reciprocated 500 times under a load of 2 kg, the gloss of the composition of the Comparative Example increased from 21.2 to 39.7 (about 87.9% increase), the gloss of the composition of Example 1 increased from 22.4 to 33.2 (about 48% increase), and the gloss of the composition of Example 2 increased from 20.3 to 26.7 (about 32% increase). Such results demonstrate that the removal of the matting agent upon wiping is smaller in the composition of the present invention than in the composition of the Comparative Example.

In addition, the compositions of the Examples showed a clear color due to a great difference in refractive index between the matting agent and the clear paint resin, but the composition of the Comparative Example showed a turbid base color. This could be confirmed by the difference in chromaticity.

In other words, because the matte clear coating compositions of Examples 1 and 2 according to the present invention contain suitable components and use an organic matting agent (polymer beads) in place of an inorganic matting agent, the matting degree, linearity, adhesion, pencil hardness, water resistance and impact resistance of the compositions of the present invention are equal to or higher than those of the composition of the Comparative Example, which contains the inorganic matting agent. In addition, the composition of the Example of the present invention has good storage stability and maintains a matt state after wiping. This suggests that the composition of the Example of the present invention is more suitable as a matte clear coating composition.

As described above, the matte clear coating composition according to the present invention has good storage stability because the matting agent does not precipitate even when the composition is stored for a long period of time, and the hiding of the base color by the matting agent is minimized, and the composition has desired physical properties, including adhesion and water resistance properties. Accordingly, the composition of the present invention can be used in a wide range of applications requiring a matt appearance, including plastic components, electronic products, and car exterior materials.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A matte clear coating composition comprising:
a paint resin having a refractive index of about 1.48-1.50 and a specific gravity of about 1.1-1.2; and
polymer beads having a refractive index that differs from the refractive index of the paint resin by about 0-0.02, and a specific gravity that differs from the specific gravity of the paint resin by about 0-0.2.

2. The matte clear coating composition of claim 1, wherein the polymer beads are contained in an amount of about 15-40 parts by weight based on 100 parts by weight of the paint resin.

3. The matte clear coating composition of claim 1, wherein the paint resin is selected from the group consisting of acrylic resins, polyester resins, and a mixture thereof.

4. The matte clear coating composition of claim 1, further comprising one or more of a surface modifier, a curing agent, and an additive.

5. The matte clear coating composition of claim 1, wherein the polymer beads are acrylic resins.

6. The matte clear coating composition of claim 5, wherein the acrylic resin is polymethylmethacrylate (PMMA), polybutylmethacrylate (PBMA), or combinations thereof.

7. The matte clear coating composition of claim 1, wherein the polymer beads have a particle size of about 10-20 μm.

8. The matte clear coating composition of claim 4, wherein the surface modifier is based on silicon or polyethylene.

9. The matte clear coating composition of claim 4, wherein the curing agent is melamine formaldehyde.

10. The matte clear coating composition of claim 4, further comprising about 1.0-2.0 wt % of one or more additives selected from the group consisting of an optical stabilizer, a pinhole preventing agent, and an anti-sagging agent.
